(19) United States
(12) Patent Application Publication
(10) Pub. No.: US 2017/0081250 A1
(43) Pub. Date: Mar. 23, 2017

(54) METHOD OF FORMING A THERMAL BARRIER COATING HAVING A POROSITY ARCHITECTURE USING ADDITIVE MANUFACTURING

(71) Applicant: Siemens Energy, Inc., Orlando, FL (US)

(72) Inventors: Ahmed Kamel, Orlando, FL (US); Anand A. Kulkarni, Charlotte, NC (US)

(21) Appl. No.: 14/856,626

(22) Filed: Sep. 17, 2015

(51) Int. Cl. C04B 41/00; C04B 38/06; C04B 41/80; B33Y 10/00; B33Y 70/00

(52) U.S. Cl. CPC C04B 41/0036; B33Y 10/00; B33Y 70/00; C04B 41/0072; C04B 41/009; C04B 41/80; C04B 38/06; C04B 2235/665; C04B 2235/9607

(57) ABSTRACT

A method, including: laser heating heat-source material (18) disposed in ceramic material (16); and sintering the ceramic material using heat energy generated in the heat-source material by the laser heating to form sintered ceramic (32) having inconsistencies (40) caused by the heat-source material.

### FIELD OF THE INVENTION

The invention relates to forming a thermal barrier coating having a porosity architecture. Specifically, the invention relates to an additive manufacturing processes that laser heats a fugitive material disposed in a ceramic material to build up a thermal barrier coating having the porosity architecture.

### BACKGROUND OF THE INVENTION

Additive manufacturing processes are widely used to produce three-dimensional parts from metal powders, polymer powders, and ceramic powders by fusing the powder to form a layer, and repeating the process to form additional layers until the part is completed. A powder bed is used to hold the component during processing and to supply powder for the additional layers. While this approach enables a layer-by-layer buildup of parts, the process is very slow and material characteristics cannot be tailored in a way possible with other processes such as when a melt pool is used. This is particularly so for ceramics such as those used in thermal barrier coatings (TBC).

Thermal barrier coatings have been employed on first and second row turbine blades and vanes as well as on combustor components exposed to the hot gas path of industrial gas turbines. In this environment TBCs are extensively applied to the hot sections and provide them protection against thermos-mechanical shock, high-temperature oxidation, and hot corrosion degradation, inter alia.

Thermal spraying (e.g. plasma spraying) is one of many methods used to produce overlay coatings (e.g. TBC) for the protection of materials from a wide range of adverse environmental, mechanical, and thermal conditions as well as for creating functional surfaces. In this process the deposit develops by successive impingement and inter-bonding among molten particles of feedstock material that are directed toward a surface. The particles of these coatings are prescribed by characteristics of the feedstock materials and the processing parameters. This enables the formation of coatings with a vast range of distinct microstructures which, in turn, alters the functionality and performance of the respective overlay coating. However, with the rapid solidification associated with this process, control of porosity of the coating depends on a multitude of parameters, including the spray ambient environment, plasma spray parameters (e.g. power level, gas flow features, spray distance etc.), and feedstock characteristics (e.g. morphology and size distribution).

Increasing firing temperatures and decreasing leakage path tolerances, both of which are enabled by TBCs, are causing a greater reliance on TBCs, and hence a demand for improved performance. Consequently, there remains room in the art for improvement.

### BRIEF DESCRIPTION OF THE DRAWINGS

The invention is explained in the following description in view of the drawings that show:

FIG. 1 schematically represents an exemplary embodiment of a process of forming a layer of sintered ceramic having an inconsistency.

FIG. 2 is a schematic side view of an exemplary embodiment of a sintered ceramic formed by the process of FIG. 1.

FIG. 3 schematically represents an alternate exemplary embodiment of a process of forming a layer of sintered ceramic having an inconsistency.

FIG. 4 is a schematic side view of an alternate exemplary embodiment of a sintered ceramic formed by the process of FIG. 3.

FIGS. 5-8 are schematic side views of various exemplary embodiments of thermal barrier coatings having plural layers of sintered ceramic and respective porosity architectures.

### DETAILED DESCRIPTION OF THE INVENTION

The present inventors have developed a unique and innovative way to create improved thermal barrier coatings (TBCs) improved functionality and performance. Many of the ceramic materials used in TBCs are transparent or translucent to lasers conventionally used in laser heating processes. This inherent characteristic has prevented TBC formation using conventional selective laser melting (SLM) and selective laser sintering (SLS) processes because the laser beam would simply pass though the ceramic material. The method disclosed herein takes advantage of the transparent and translucent nature of ceramics by placing a heat source material in the ceramic material. An energy beam (e.g. laser beam) is used to irradiate the heat source material and generate heat therein. The heat-source material absorbs the laser energy and is heated until sufficient heat is generated to sinter adjacent ceramic material. The heat-source material is dispersed in sufficient quantity and distribution that the heat generated in the heat source material is sufficient to sinter the entire volume in which the heat-source material is disposed.

An example volume of ceramic material is a layer of ceramic material. In such an exemplary embodiment, a layer of ceramic material with heat-source material therein may be processed to form a sintered layer. Other layers may be formed thereon iteratively in an additive manufacturing process to form a TBC having inconsistencies therein caused by the heat-source material. In an exemplary embodiment, the heat-source material is a fugitive material that may be partially or fully volatized during the laser processing of the layer. In this case the inconsistencies may include random or patterned voids where the fugitive material volatized. Alternately, some or all of the fugitive material may not be volatized during the laser processing of the layer, in which case the remaining fugitive material may serve another purpose in the interim or as part of a component in an operating gas turbine engine before fully volatizing.

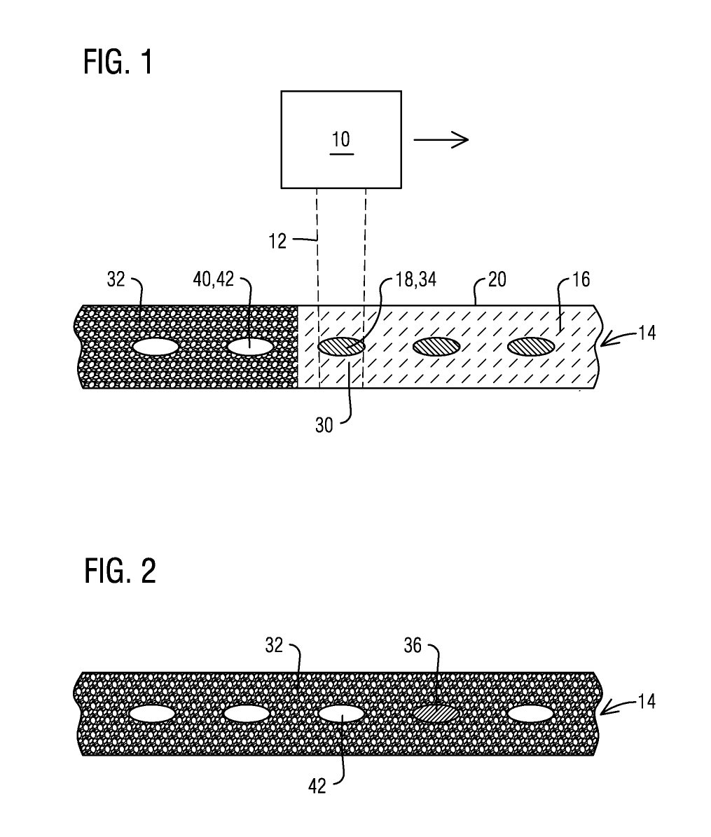

In FIG. 1 a laser 10 directs a laser beam 12 toward a layer 14 including ceramic material 16. The ceramic material 16 may include, for example, yttrium, ytterbium, gadolinium, lanthanum, aluminum, silicon and zirconium and may be in, for example, powder form. A conventional selective laser sintering (SLS) or selective laser melting (SLM) machine adapted to process alloy powder may generate a laser beam having operating parameters to control melt pool characteristics. The operating parameters include operating frequency (e.g. 1024 to 1064 nanometers), and spot size, etc. However, the ceramic materials 16 are at least translucent and may be entirely transparent to the conventional SLS/SLM laser beams. This characteristic prevents laser sintering and laser melting of the ceramic in the conventional processes.

Innovatively, in the process disclosed herein, this characteristic is relied upon to permit the laser beam 12 to pass through the ceramic material 16 so that the laser beam 12 may reach a heat-source material 18. The heat-source material 18 is at least partly submerged in the ceramic material 16. As shown the heat-source material 18 is fully submerged. Either or both is acceptable in the layer 14. If the heat-source material 18 is fully submerged, a surface 20 of the layer 14 will be relatively smooth after final processing. If the heat-source material 18 is partly submerged then the surface 20 of the layer 14 may be relatively less smooth after final processing.

The laser beam 12 is directed at the heat-source material 18, heating the heat-source material 18. The heat-source material 18 is selected so that it may be heated by the laser beam 12 to a temperature and for a time sufficient to sinter adjacent ceramic material 30 into sintered ceramic 32. The heat-source material 18 is dispersed throughout the layer 14 in a density and volume sufficient to sinter the entire layer 14 of ceramic material 16. As can be seen here, the laser beam 12 has previously heated heat source material 18 to create the sintered ceramic 32 nearby the processed heat source material 18, while ceramic material 16 nearby unprocessed heat source material 18 (or heat source material 18 in the beginning stages of processing) remains unsintered.

Accordingly, once all of the heat-source material 18 is processed by the laser beam 12 all of the ceramic material 16 is sintered, thereby forming a sintered ceramic layer. In the case of transparent ceramic material 16 the ceramic material 16 absorbs a negligible amount of energy from the laser beam 12, and the heat-source material 18 is essentially the sole source of heat for the ceramic material 16. In the case of transparent material, some energy from the laser beam 12 may also be absorbed directly by the ceramic material 16.

The presence of the heat-source material 18 forms an inconsistency 40 in the morphology of the layer 14 when compared to a morphology of a layer of ceramic that is sintered without heat-source material 18 therein. The heat-source material 18 may a fugitive material 34 that at least partly volatizes during the laser processing. The fugitive material in particular can be any material that easily combusts and enables transfer of heat to surrounding ceramic particles. Example materials include polyester, graphite, or polymethyl methacrylate. In this exemplary embodiment the fugitive material 34 fully volatizes, leaving a void 42 in the sintered ceramic 32. The void 42 takes a shape generally consistent with a shape of the fugitive material 34. Accordingly, where the fugitive material 34 is a relatively large and discrete body when compared to the ceramic powder, the void 42 is likewise relatively large and discrete within the layer 14.

FIG. 2 is a schematic side view of the layer 14 formed by the process of FIG. 1, where the layer 14 is composed of sintered ceramic 32 having voids 42 therein. The voids 42 reduce a density of the sintered ceramic 32 and hence increase a porosity of the sintered ceramic 32. In this way an amount and a distribution of the porosity of the sintered ceramic 32 may be controlled, and thereby tailored. The layer 14 shown in FIG. 2 may be one layer produced in an additive manufacturing process where additional layers (not shown) are iteratively processed thereupon until the desired number of layers is reached and a thermal barrier coating (TBC) (not shown) is formed.

Alternately, the heat-source material 18 may not volatize at all, leaving remaining material 36 as indicated for one of the inconsistencies 40. In another alternate exemplary embodiment the fugitive material 34 may only partly volatize, leaving remaining material of reduced volume when compared to its pre-processed volume. In yet another exemplary embodiment, some heat-source material 18 may be fugitive, and some may not, and there may be composite heat-source material 18 having both fugitive material 34 and non-fugitive material. The remaining material 36 may be expected to volatize during operation in a gas turbine engine, or may be expected to survive. Any remaining material 36 may be relied upon to perform an additional function during handling and/or during operation in the gas turbine engine. For example, remaining material 36 may be a marker material and may be disposed in the sintered ceramic such that it is more densely packed deeper in the TBC. Exhaust from the gas turbine engine may be monitored for this marker material and an amount of wear of the TBC may be assessed.

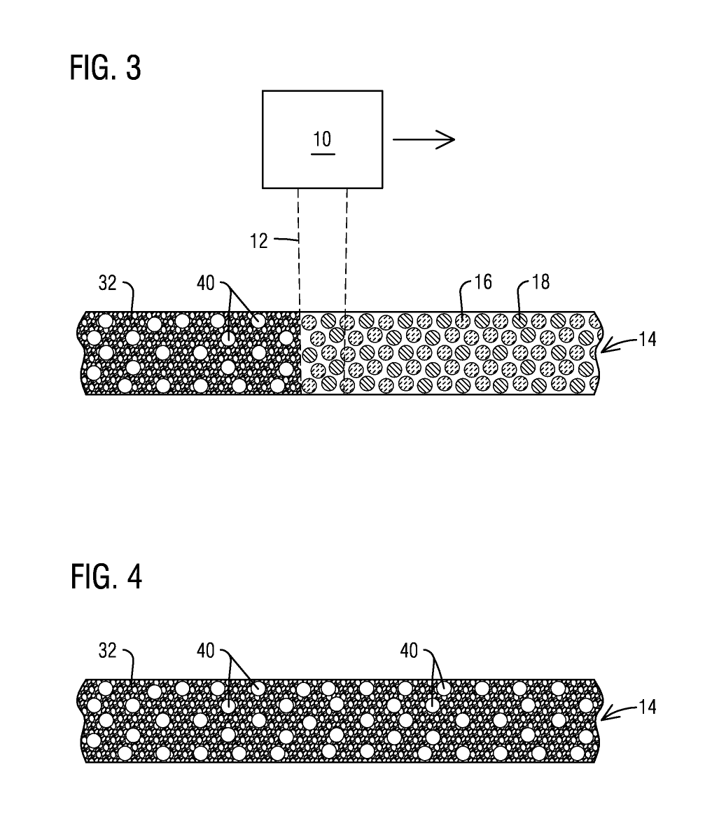

FIG. 3 schematically represents an alternate exemplary embodiment of the process of forming a layer 14 of sintered ceramic 32 having inconsistencies 40. Here the heat-source material 18 is in powder form as well as the ceramic material 16. As the laser beam 12 processes the layer 14 it forms the sintered ceramic 32 having finer inconsistencies 40. As can be seen in FIG. 4, once fully processed by the laser beam 12 the layer 14 is composed of sintered ceramic 32 having a relatively uniform porosity when compared to the morphology of the porosity shown in FIG. 2. Thus, layers 14 in FIGS. 2 and 4 may have the same amount of porosity but the morphology may be entirely different. Alternately, the amount of porosity may also be varied.

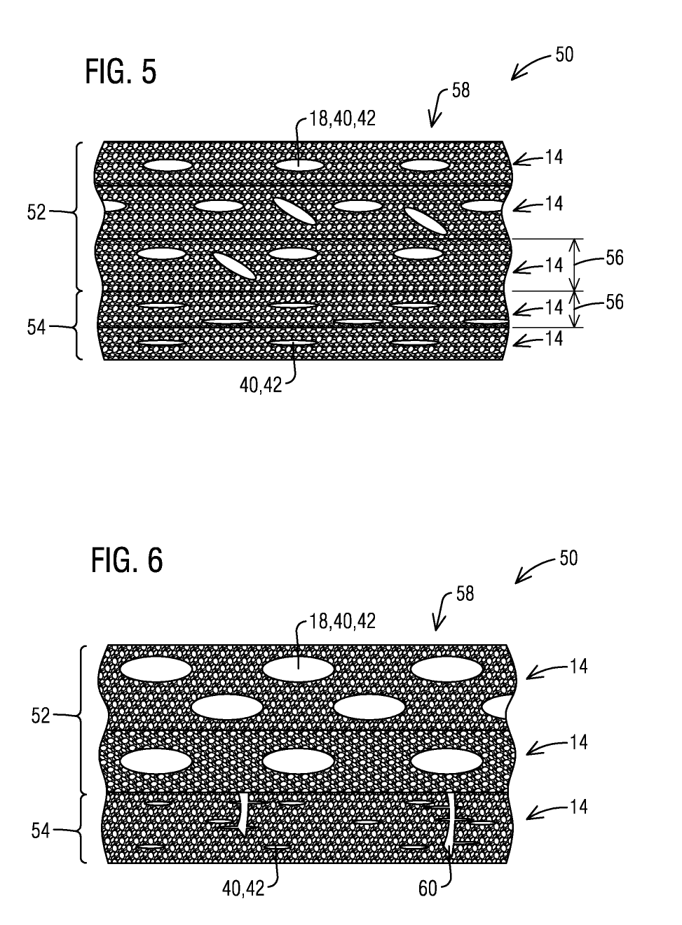

Porosity affects thermal conductivity, strain tolerance, damping/internal friction, and, abradability, inter alia, and so the ability to control porosity within a layer 14, coupled with the ability to form a TBC in a layer-by layer manner through an additive manufacturing process as disclosed herein, enables the formation of TBCs having local variations in functionality. FIG. 5 discloses an exemplary embodiment of a TBC coating 50 having plural layers 14 formed via the additive manufacturing process. An upper region 52 exhibits a first, relatively more porous morphology and a lower region 54 exhibits a second, relatively less porous morphology. The first, relatively more porous morphology may be, for example, eight to twelve percent porosity, which is better for abradability and lower thermal conductivity. The second, relatively less porous morphology is better for adhesion and strain tolerance. It can also be seen that a thickness 56 of the layers may be varied as desired within process limits to match a desired process speed with the porosity of the layer being processed etc. Together the different porosity morphologies define a porosity architecture 58 well-suited for adhering a TBC to a substrate at the lower region 54 and using the upper region 52 as part of, for example, a clearance control arrangement at tips of blades in a gas turbine engine.

FIG. 6 discloses an alternate exemplary embodiment of the TBC coating 50 having plural layers 14 formed via the additive manufacturing process. The upper region 52 again exhibits a first, relatively more porous morphology and the lower region 54 exhibits a second, relatively less porous morphology. The upper region 52 may again exhibit, for example, the same eight to twelve percent porosity, but with a different morphology. Likewise, the lower region 54 may again exhibit the same porosity as in FIG. 5, but with a different morphology that includes vertical micro-cracks 60. The micro-cracks or macro-cracks may be formed by, for example, zirconia releasing stress during the formation process. This would require adequate control of thermal heat to the ceramic, similar to the process established for conventional plasma sprayed process for a dense vertically cracked structure.

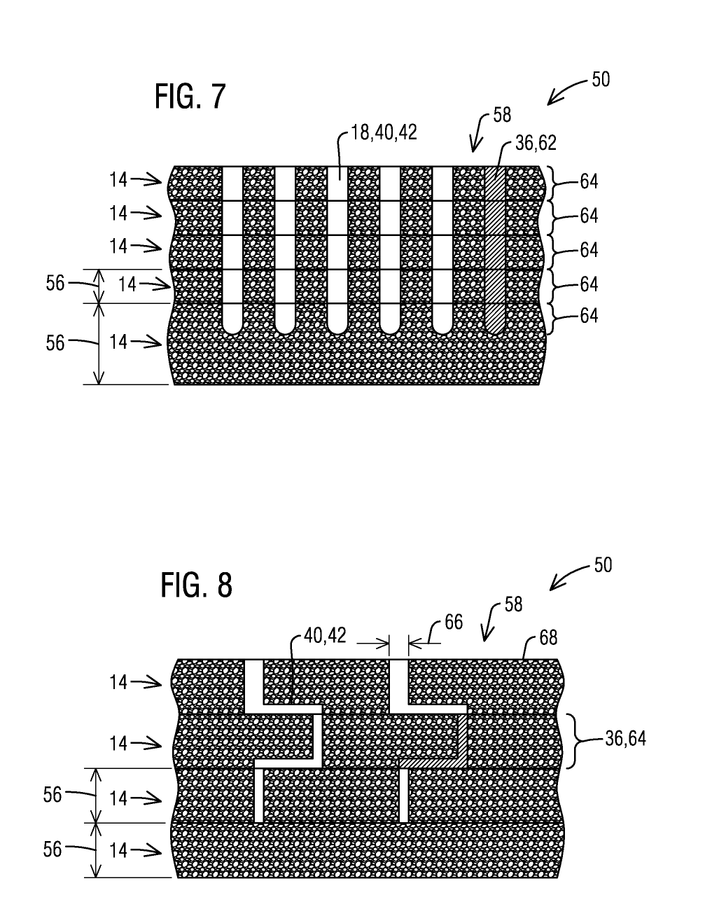

FIG. 7 discloses an alternate exemplary embodiment of the TBC coating 50 having plural layers 14 formed via the additive manufacturing process. In this exemplary embodiment the heat-source material is a preform 62 that may be sectioned and each section 64 applied in a respective layer 14. One preform 62 is shown as remaining material 36 to aid in understanding. As the layers 14 buildup the inconsistency 40 takes the shape of the preform 62 in assembled form. Accordingly, the inconsistency created can span plural layers 14 as a continuous inconsistency. If the heat-source material 18 is removed, the resulting porosity architecture 58 likewise spans plural layers 14. This high degree of control enables local tailoring within a layer 14 and layer-by-layer to achieve a wide variety of complex porosity architectures 58. This, in turn, enables a great deal of control of the local functionality of the TBC coating 50.

FIG. 8 discloses an alternate exemplary embodiment of the TBC coating 50 having plural layers 14 formed via the additive manufacturing process. In this exemplary embodiment the heat-source material is a preform 62 that may be sectioned and each section 64 applied in a respective layer 14. One section 64 is shown as remaining material 36 to aid in understanding. In this exemplary embodiment it can be seen that none, one, or more than one of the sections 64 may be remaining material 36. Accordingly, remaining material 36 may be pattered laterally and vertically as desired. In this exemplary embodiment it can be seen that the resulting inconsistency 40 takes a more complex path through the TBC coating 50, and represents only one of any number of possible geometries. Accordingly, when the heat-source material 18 used is a fugitive material 34, the resulting porosity architectures 58 may be equally complex. Also visible is a width 66 that is relatively larger toward a surface 68 of the TBC coating 50 than elsewhere, indicating additional design freedom.

From the foregoing it can be seen that the inventors have devised an innovative and unique method of creating a TBC in a layer-by-layer, additive manufacturing process. The TBC can be tailored locally within each layer as well as layer-by-layer to achieve a desired porosity architecture tailored to desired local functionality. The method disclosed enables this process using conventional equipment in an unconventional way, and thereby costs little to implement. Consequently, this represents an improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method, comprising:
laser heating heat-source material disposed in ceramic material; and
sintering the ceramic material using heat energy generated in the heat-source material by the laser heating to form sintered ceramic comprising inconsistencies caused by the heat-source material.

2. The method of claim 1, further comprising using a ceramic material that is transparent or translucent to a laser beam used to laser heat the heat-source material.

3. The method of claim 2, further comprising passing the laser beam through the ceramic material when laser heating the heat-source material.

4. The method of claim 1, wherein the sintered ceramic defines a layer of a ceramic coating comprising plural layers, the method further comprising forming the plural layers by repeating the laser heating and sintering steps for each layer as part of an additive manufacturing process.

5. The method of claim 4, wherein the heat-source material comprises a fugitive material, the method further comprising at least partly volatizing the fugitive material during the laser heating and sintering steps.

6. The method of claim 5, wherein the inconsistencies form a relatively greater porosity in an upper portion of the ceramic coating and a relatively lesser porosity in a lower portion of the ceramic coating.

7. The method of claim 5, wherein the inconsistencies form a porosity architecture that spans the plural layers.

8. A method, comprising:
using a laser heating process to generate heat energy in a fugitive material; and
using the heat energy to sinter ceramic material surrounding the fugitive material and to volatize the fugitive material, thereby forming a void in sintered ceramic.

9. The method of claim 8, further comprising directing a laser beam used in the laser heating process through transparent or translucent ceramic material.

10. The method of claim 9, further comprising fully submerging the fugitive material in the ceramic material before directing the laser beam through the transparent or translucent ceramic material.

11. The method of claim 8, further comprising using a selective laser melting apparatus configured to process alloy powder to perform the laser heating process.

12. The method of claim 8, further comprising using a pulsed laser beam comprising an operating frequency of 1024 to 1064 nanometers to perform the laser heating process.

13. The method of claim 8, wherein the sintered ceramic is formed as one iteration of plural iterations of an additive manufacturing process, the method further comprising forming a ceramic coating comprising plural sintered ceramics via the additive manufacturing process.

14. The method of claim 13, further comprising forming a coating comprising a porosity architecture comprising voids in an upper region and different voids and at least one of micro-cracks and macro-cracks in a lower region.

15. A method, comprising:
disposing fugitive material in a layer of a ceramic material; and
laser heating the fugitive material to a temperature sufficient to volatize the fugitive material and to sinter the ceramic material to form a sintered ceramic layer comprising an inconsistency caused by the volatized fugitive material.

16. The method of claim 15, further comprising using a laser beam comprising a wavelength of 1064 nanometers to laser heat the fugitive material through a ceramic material that is transparent or translucent to the wavelength.

17. The method of claim 16 further comprising fully submerging the fugitive material in the ceramic material before directing the laser beam through the transparent or translucent ceramic material.

18. The method of claim 15, wherein the fugitive material comprises a polyester, graphite, or polymethyl methacrylate.

19. The method of claim 15, wherein the fugitive material comprises a powder form.

20. The method of claim 15, wherein the fugitive material comprises a preform.
